(19) United States
(12) Patent Application Publication
(10) Pub. No.: US 2018/0012251 A1
(43) Pub. Date: Jan. 11, 2018

(54) SYSTEMS AND METHODS FOR AN ATTENTION-BASED FRAMEWORK FOR CLICK THROUGH RATE (CTR) ESTIMATION BETWEEN QUERY AND BIDWORDS

(71) Applicant: Baidu USA, LLC, Sunnyvale, CA (US)

(72) Inventors: Nan Du, Palo Alto, CA (US); Yaliang Li, Buffalo, NY (US); Wei Fan, Sunnyvale, CA (US)

(73) Assignee: Baidu USA LLC, Sunnyvale, CA (US)

(21) Appl. No.: 15/206,966

(22) Filed: Jul. 11, 2016

(51) Int. Cl. G06Q 30/02; G06F 17/30

(52) U.S. Cl. CPC G06Q 30/0246; G06F 17/30952; G06F 17/3053; G06F 17/30864

(57) ABSTRACT

The present invention relates generally to an attention-based model framework for click through rate (CTR) prediction between a search query and bidword. Aspects of the present invention include using vector representation of a search query and a bidword. In embodiments, an attention-based model is used to predict CTR for a search query-bidword pair. In embodiments, a bidword with a highest CTR prediction for a given query is used to place an advertisement. Thus, a bidword may be used even without an exact match to a search query.

### A. FIELD OF INVENTION

The present invention relates generally to online advertising and more particularly to mapping a user query to a most relevant bidword.

### B. DESCRIPTION OF THE RELATED ART

In online advertising one of the objectives is for advertisers to put their advertisements in front of potential customers. In other words, online advertisers would like to place their advertisements or webpages where interested users will see them and have a chance to respond and purchase the advertised product or service.

There are many ways advertisers attempt to achieve their objective. One way is to use search queries to guess at a user's interest and then put an appropriate advertisement or webpage in front of that user. One way that an advertiser may place its advertisement is through the use of bidwords.

In online advertising, bidwords are used by advertisers to promote their products or service. A bidword is a term, phrase, question, or sentence, e.g., “toy” or “what is the best toy,” that an advertiser may bid on and purchase. In prior art systems, when a user generates a query, for example, in a search engine, and a bidword is used, then the advertiser who owns that exact bidword may place their advertisement in front of the user in response to the user query.

For example, a toy company might own the bidwords “toy” and “what is the best toy.” That toy company may then place its advertisements in front of the user when the user does a search for “toy” or “what is the best toy.” However, if a user searches for “best child educational product,” the advertiser will not place its advertisement, unless it also owns that bidword.

The prior art solutions must have an exact match between bidword and query terms in order to trigger advertisement or webpage placement. If a search query is close, but not an exact match to one or more bidwords, the advertisement will not be placed.

Accordingly, what is needed is systems and methods to perform mapping between search query terms and bidwords in such a way as to maximize click through rate.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the spirit and scope of the invention to these particular embodiments. These drawings shall in no way limit any changes in form and detail that may be made to the invention by one skilled in the art without departing from the spirit and scope of the invention.

FIG. 1 depicts a block diagram of a training phase of an attention-based model for click through rate prediction according to embodiments in this patent document.

FIG. 2 depicts a flow chart of a training phase of an attention-based model for click through rate prediction according to embodiments in this patent document.

FIG. 3 depicts a block diagram of a click through rate prediction system correlating a query and a bidword according to embodiments in this patent document.

FIG. 4 depicts a block diagram of an attention-based model for click through rate prediction according to embodiments in this patent document.

FIG. 5 depicts a block diagram of an attention-based model of according to embodiments in this patent document.

FIG. 6 depicts a flow chart of an attention-based model for click through rate prediction according to embodiments in this patent document.

FIG. 7 depicts a block diagram of a computing system according to embodiments of the patent document.

### DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded. Furthermore, the use of certain terms in various places in the specification is for illustration and should not be construed as limiting. Any headings used herein are for organizational purposes only and shall not be used to limit the scope of the description or the claims. Each reference mentioned in this patent document is incorporate by reference herein in its entirety.

It shall be noted that: (1) certain steps may optionally be performed; (2) steps may not be limited to the specific order set forth herein; (3) certain steps may be performed in different orders; and (4) certain steps may be done concurrently.

The present invention relates in various embodiments to devices, systems, methods, and instructions stored on one or more non-transitory computer-readable media involving attention-based models. Such devices, systems, methods, and instructions stored on one or more non-transitory computer-readable media can result in, among other advantages, the prediction of click through rates correlating a query to bidwords.

It shall also be noted that although embodiments described herein may be within the context of correlating a query with bidwords, the invention elements of the current patent document are not so limited. Accordingly, the invention elements may be applied or adapted for use in other contexts.

In online advertising one of the objectives is for advertisers to put their advertisements or their webpages in front of potential customers. In other words, online advertisers would like to place their advertisements or web pages where interested people will see them and have a chance to respond and purchase the advertised product or service.

There are many ways advertisers attempt to achieve their objective. One way is to use search queries to guess at a user's interest and then put an appropriate advertisement in front of that user. One way that an advertiser may place its advertisement is through the use of bidwords. A bidword is a term, phrase, question, or sentence, e.g., “toy” or “what is the best toy,” that an advertiser can bid on and purchase.

In embodiments, a bidword that is not an exact match to a search query can trigger the advertisement placement associated with the bidword. In embodiments, the systems and methods described herein can rank bidwords based on predicted click through rate (CRT) and use the highest ranked bidword to return an advertisement or webpage from a particular search query. CRT is a ratio of users who click on a specific link to the number of total users who view a certain webpage. Suggesting proper bidwords to the corresponding query can significantly improve webpage clickability and conversion rates.

In embodiments, the systems and methods described herein suggest relevant bidwords to a user query. In embodiments, the attention-based model makes it possible to reveal which words in the search query contribute the most to the final providing bidword. That prediction can help advertisers better understand their users' attention.

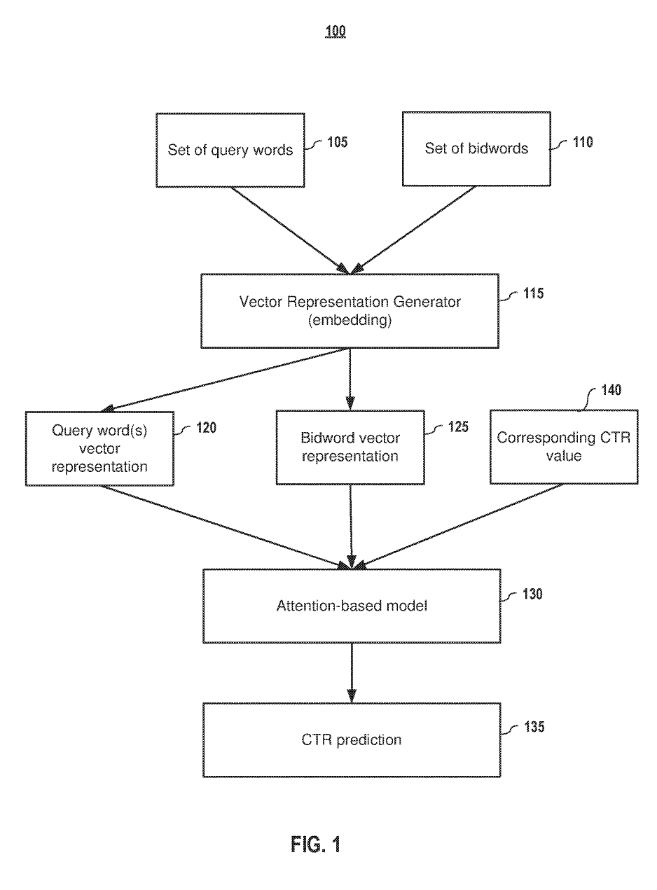

FIG. 1 depicts a block diagram of a training or learning phase of an attention-based model for click through rate prediction according to embodiments in this patent document. FIG. 1 shows a training phase of an attention-based model using deep learning techniques.

The system of embodiments described herein improves on the prior art advertising system by providing systems and methods to map a query to a bidword and to determine which keywords in the query contribute most to the final providing bidword, which will help advertisers better understand their users' attention. Linking high quality bidwords to the user query leads to improved advertisement clickability and increased conversion rates. The market size is tens of millions of dollars.

In embodiments, in order to use an attention-based model to predict CTR for each query-bidword pair, the model can be trained to learn user behavior. The learning system architecture is shown in FIG. 1. FIG. 1 shows inputting a set of query words into a vector representation generator 115. FIG. 1 also shows inputting a set of bidwords 110 into vector representation generator 115.

In embodiments, vector representation generator 115 converts a word (either a query word or a bidword) into a vector representation. The vector representation generator 115 may use any method for achieving a vector representation. Various methods for vector representation include, but are not limited to, Skip-gram model or continuous bag of words (Word2Vec), GloVe, one-hot-representation, or other word embedding representation.

Vector representation generator 115 takes words as an input and outputs a 1×D vector representation. In embodiments, a bidword is represented as a single 1×D vector.

Vector representation generator 115 represents words in a continuous vector space where semantically similar words are mapped to nearby points. In embodiments, vector representations use a notion that words that appear in the same contexts share semantic meaning.

The Word2Vec method uses a group of models to produce word embedding. These models may be shallow, two-layer neural networks that are trained to reconstruct linguistic contexts of words.

GloVe is an unsupervised learning algorithm for obtaining vector representations of words.

One-hot-representation assigns each word in the vocabulary a number and represents the number by using all zeros and a “1” to indicate the position associated with the number associated with the word.

FIG. 1 shows the query word vector representation 120, the bidword representation 125, and corresponding CTR value 140 are used as inputs to an attention-based model 130. In embodiments, a bidword vector representation is a single bidword vector representation. In embodiments, the single bidword representation may computed by using a vector representation of each word in the bidword and taking an average of those vector representations. In embodiments, the single bidword representation may be achieved using a recurrent neural network (RNN).

The attention-based mode 130 assigns each word a probability and combines the probabilities into a weighted probability.

In embodiments, query words q₁, q₂, q₃, q_{N} are used, which are acquired after word segmentation from the query. Each representation is a 1×D vector. In embodiments, one-word embedding representation of bidword, b, which is a 1×D vector is used. In embodiments, a CTR value, c, for the corresponding query and bidword is also used.

Embodiments may use the function:

Minₚ_{ᵢ}_{,W,W}_{ₚ}=∥(WIIΣᵢ^{N}pᵢ*qᵢ)+b)−c)μ² (1)

Where pᵢ=Wₚ*(qᵢ+b) is the probability assigned for each query word; Wₚ is a D by 1 matrix which projects the combined representation Pᵢ=Wₚ*(qᵢ+b) from D dimension into 1; Wₚ is a matrix measuring the relationship between each query word and bidword. Thus, as the formula shows, the model learns a probability, pᵢ, for each query word corresponding to the bidword (that is the reason pᵢ is calculated on both qᵢ and b). The representation may be weighted and combined to make a regression on the CTR, c, via a normal. In embodiments, all the parameters used to learn pᵢ, W, and Wₚ can be achieved by the above formula via gradient descent.

In embodiments, the weighted probability is the CTR prediction. Using the architecture of FIG. 1, the attention-based model 130 can learn the CTR's of various query terms and bidword pairs.

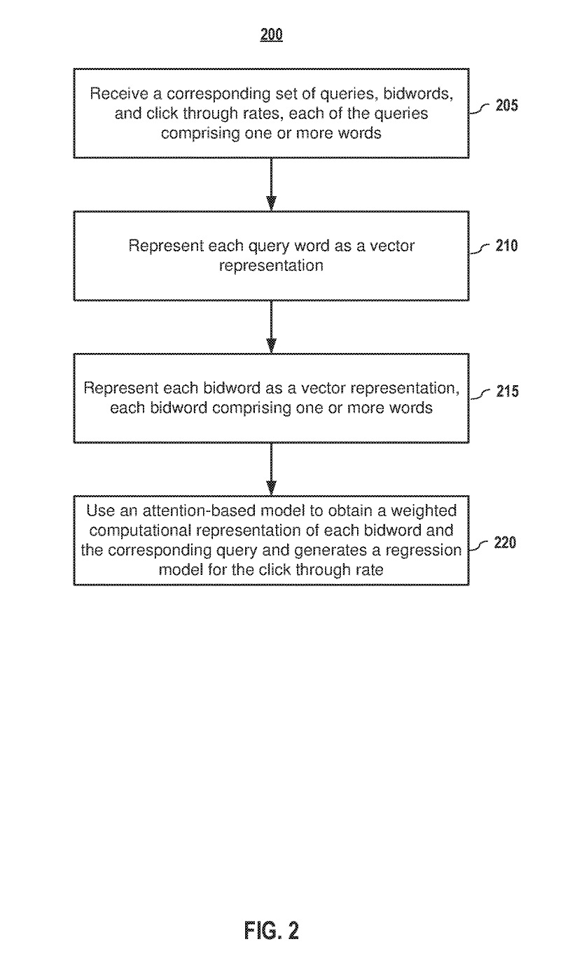

FIG. 2 depicts a flow chart of a training phase of an attention-based model for click through rate prediction according to embodiments in this patent document. FIG. 2 shows the flow associated with the system architecture of FIG. 1. FIG. 2 shows receiving a corresponding set of queries, bidwords, and click through rates, each of the queries comprising one or more words 205. FIG. 2 also shows representing each query word as a vector representation 210. As in FIG. 1, the vector representation can be achieved using any vector representation, including, but are not limited to, Skip-gram model or continuous bag of words (Word2Vec), GloVe, one-hot-representation, or other word embedding representation. In embodiments, the bidword may be represented as a single vector.

FIG. 2 shows representing each bidword as a vector representation, each bidword comprising one or more words 215. In embodiments, a bidword vector representation is a single bidword vector representation. In embodiments, the single bidword representation may computed by using a vector representation of each word in the bidword and taking an average of those vector representations. In embodiments, the single bidword representation may be achieved using a recurrent neural network (RNN).

FIG. 2 shows using an attention-based model to obtain a weighted computational representation of each bidword and the corresponding query and generates a regression model for the click through rate 220. In embodiments, the attention-based model assigns a probability associated with each word and then computes a combined, weighted probability. In embodiments, the formula, equation 1, described with reference to FIG. 1 can be used to obtain the weighted probability and CTR.

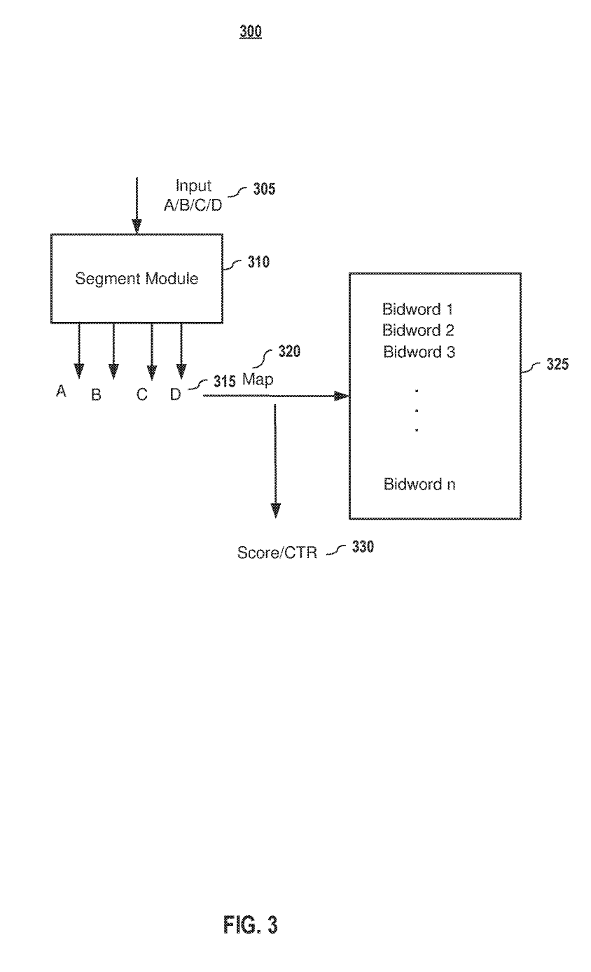

FIG. 3 depicts a block diagram of a click through rate prediction system correlating a query and a bidword according to embodiments in this patent document. FIG. 3 shows a system architecture for CTR prediction at a high level. Once the attention-based model has learned CTR's and queries, it can be used to predict CTR's for any query.

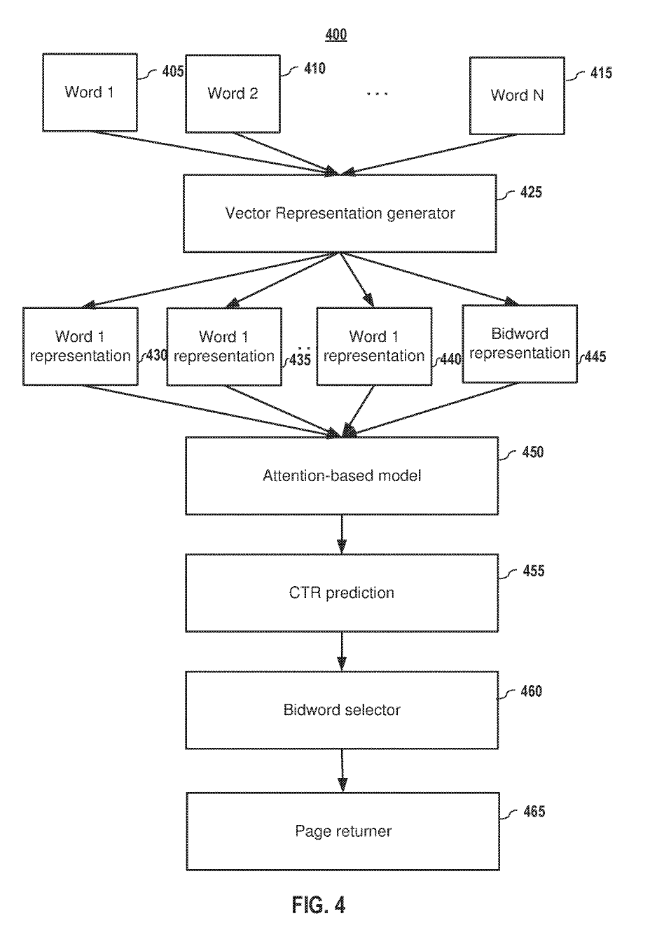

A query can be a single word or a phrase. In some languages, a query input A/B/C/D 305 may be input into a segment module 310. Segment module 310 segments the query into its components A, B, C, and D 315. Mapping 320 is used to compare the query to the list of bidwords 325 and predict CTR 330. Mapping 320 may use an attention-based model as described in relation to FIG. 4.

In the prior art systems and methods, mapping was only capable of being a direct comparison. Therefore, if the query word 315 was exactly a bidword on bidword list 325, then the bidword would be returned. However, in embodiments, a bidword may be returned based on predicted CTR even when the query word 315 is not an exact match to the bidword on bidword list 325.

For example, a search query can be the phrase “a toy for my son.” That search query may be segmented into words, “a,” “toy,” “for,” “my,” and “son.” Each word would be mapped to a bidword, even if there is no exact match with a bidword. In embodiments, the bidwords may be scored based on a CTR prediction.

FIG. 4 depicts a block diagram of an attention-based model for click through rate prediction according to embodiments in this patent document. FIG. 4 shows query words, word 1 405, word 2 420 through word n 415, as inputs to a vector representation generator 425. In embodiments, vector representation generator 425 converts a word (either a query word or a bidword) into a vector representation. The vector representation generator 425 may use any method for achieving a vector representation. Various methods for vector representation include, but are not limited to, Skip-gram model or continuous bag of words (Word2Vec), GloVe, one-hot-representation, or other word embedding representation.

Vector representation generator 425 takes words as an input. Vector representation generator 425 outputs a vector representation. Vector representation generator 425 represents words in a continuous vector space where semantically similar words are mapped to nearby points. In embodiments, vector representations use a notion that words that appear in the same contexts share semantic meaning.

The Word2Vec method uses a group of models to produce word embedding. These models may be shallow, two-layer neural networks that are trained to reconstruct linguistic contexts of words.

GloVe is an unsupervised learning algorithm for obtaining vector representations of words.

One-hot-representation assigns each word in the vocabulary a number and represents the number by using all zeros and a one to indicate the position associated with the number associated with the word.

In embodiments, a bidword vector representation is a single bidword vector representation. In embodiments, the single bidword representation may computed by using a vector representation of each word in the bidword and taking an average of those vector representations. In embodiments, the single bidword representation may be achieved using a recurrent neural network (RNN).

FIG. 4 shows, in embodiments, the query word vector representation, word 1 representation, q₁, 430, word 2 representation, q₂, 435, word n representation, q_{N}, and the bidword representation 445 are used as inputs to an attention-based model 450. Each vector representation is a 1×D vector. In embodiments, a bidword may be represented as a single 1×D vector.

Once the model has been well trained, the input may be the query word or words and a bidword and the corresponding CTR value may be predicted using the below formula:

prediction=W((Σᵢ^{N}pᵢ*qᵢ)+b) (2)

In embodiments, the attention-based mode 450 assigns each word a probability and combines the probabilities into a weighted probability. In embodiments, the weighted probability is the CTR prediction.

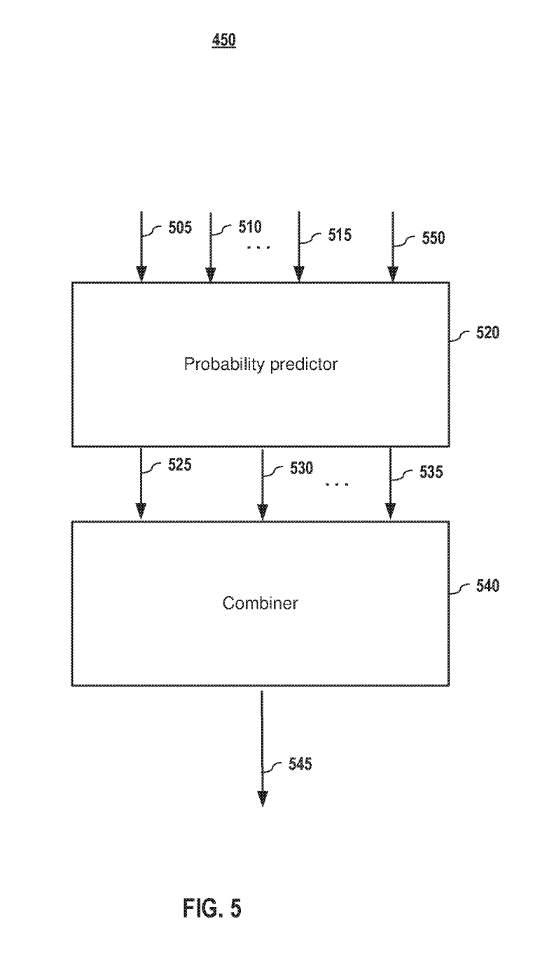

Using the architecture of FIG. 4, the attention-based model can predict the CTR's of various query terms and bidword pairs. The attention-based model outputs a CTR prediction 455. Attention-based model 450 will be described below with respect to FIG. 5.

Applying, the example above with reference to FIG. 3 where the query is “a toy for my son” to the embodiment shown in FIG. 4, the query is divided into words. Word 1 405 would be a. Word 2 410 would be “toy.” Word 3 would be “for.” Word 4 would be “my.” Word 6 would be “son.” In embodiments, each word and the bidword can be represented as vectors using vector representation 425.

Vector representations for word 1 430, word 2 435, word 3, word 4, word 5, word 6, and a bidword combination 445 may be used as inputs to an attention-based model 450. In embodiments, the attention-based model 450 assigns a probability to each vector representation for each word. In embodiments, the attention-based model 450 also combines the probabilities into one score, which is the CTR prediction for that query-bidword pair.

In embodiments, the CTR prediction is used by bidword selector 460 to select top scoring bidwords. In embodiments, the top scoring bidwords can be used by page returner 465 to determine advertisements or webpages to return to the user in response to the query based on the top scoring bidwords. Since the CTR has been predicted, using the top scoring bidwords to return the advertisements or webpages, will increase the CTR of the search results.

The attention-based model may be run iteratively on other bidwords to predict a score for other bidwords with that particular query. One of ordinary skill in the art will appreciate that the above example is intended to be an example only and not be limiting.

FIG. 5 depicts a block diagram of an attention-based model according to embodiments in this patent document. FIG. 5 shows attention-based model 450 in more detail. FIG. 5 shows attention based model 450 takes as inputs vector representations of words 1-n 505, 510, and 515. Vector representation inputs 505, 510, and 515 are input to a probability predictor 520. Vector representation of bidword or bidword combination 550 is also input into probability predictor 520. Bidword combination 550 may be an average of bidword vector representations or may use recurrent neural network (RNN) learning to combine the bidwords. Bidword combination 550 may be a vector representation of a single bidword or a bidword combination. Probability predictor 520 and combiner 540 implement the formula in equation 2 described with reference to FIG. 4.

Probability predictor 520 assigns each word a probability association with a particular bidword. Probability predictor outputs a probability associated with each word 525, 530, and 535. Each probability 525, 530, and 535 is input to a combiner 540. Combiner 540 takes a weighted combination of the probabilities to output a single probability or CTR. The single probability represents the click through rate for the query (the set of words input to the attention-based model) with a particular bidword or bidword combination. The attention-based model may be run with respect to a plurality of bidwords or bidword combinations to determine the highest rated bidword or bidwords.

Combiner 540 may perform any combination of the probabilities. In embodiments, a weighted average is used. In other embodiments, recurrent neural network (RNN) learning is used to combine the probabilities.

In embodiments, the output of the combiner is a CTR prediction. The CTR prediction may be used to place an advertisement or webpage in response to a search query. A set of top scoring bidwords may be identified based on CRT prediction. The highest scoring bidwords may be used to place the advertisement or webpage. For example, in the example above, the bidword might be “boys toys.” The bidword “boys toys” has an owner with a corresponding advertisement or webpage that may be placed in response to the query “a toy for my son.”

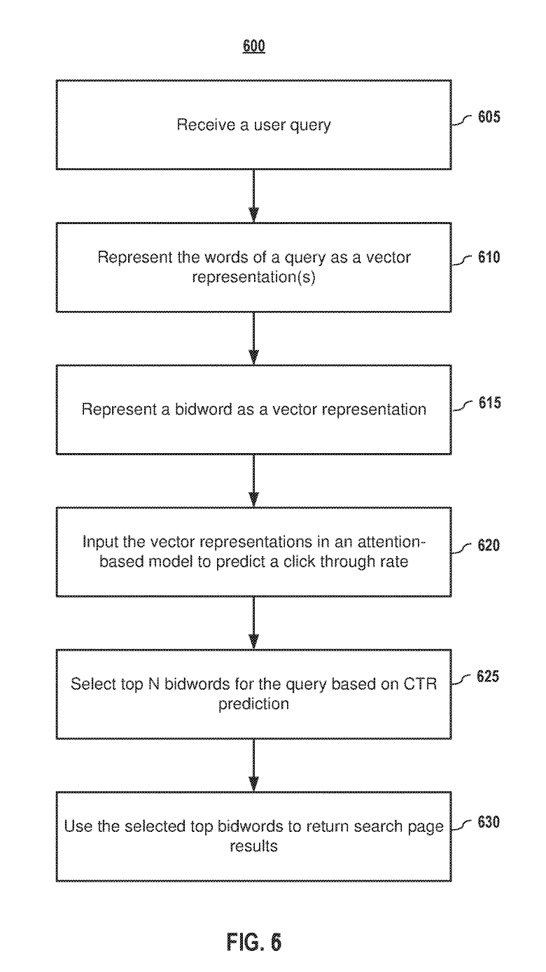

FIG. 6 depicts a flow chart of an attention-based model for click through rate prediction according to embodiments in this patent document. FIG. 6 shows receiving a user query 605. FIG. 6 shows representing the words of a user query as a vector representation 610. FIG. 6 also shows representing a bidword as a vector representation 615. In embodiments, the word vector representations and the bidword representations are inputs to an attention-based model to predict a CTR 620. Based on the CTR prediction a selection of top n bidwords may be selected 625. Those top bidwords may be used to return the results to the search page 630.

Again, returning to the above example, in embodiments, webpages may be returned based on possible bidwords “boys toys,” “toy,” “kids toys,” if they score the highest in CTR prediction.

One of ordinary skill in the art will appreciate that various benefits are available as a result of the present invention.

One of ordinary skill in the art will appreciate that one benefit as a result of the present invention is the ability to rank bidwords based on predicted CTR and use the highest ranked bidwords to return an advertisement or webpage from a particular search query.

Aspects of the present patent document are directed to a computing system. For purposes of this disclosure, a computing system may include any instrumentality or aggregate of instrumentalities operable to compute, calculate, determine, classify, process, transmit, receive, retrieve, originate, route, store, display, communicate, manifest, detect, record, reproduce, handle, or utilize any form of information, intelligence, or data for business, scientific, control, or other purposes. For example, a computing may be a personal computer (e.g., desktop or laptop), tablet computer, mobile device (e.g., personal digital assistant (PDA) or smart phone), server (e.g., blade server or rack server), a network device, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

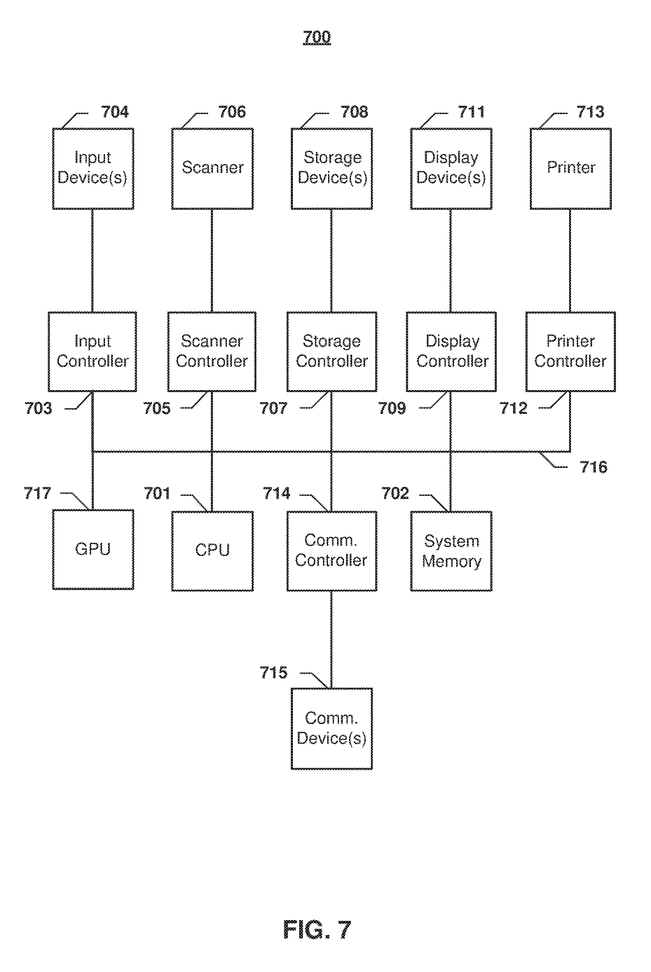

FIG. 7 depicts a block diagram of a computing system 700 according to embodiments of the present invention. It will be understood that the functionalities shown for system 700 may operate to support various embodiments of a computing system—although it shall be understood that a computing system may be differently configured and include different components. As illustrated in FIG. 7, system 700 includes one or more central processing units (CPU) 701 that provides computing resources and controls the computer. CPU 701 may be implemented with a microprocessor or the like, and may also include one or more graphics processing units (GPU) 717 and/or a floating point coprocessor for mathematical computations. System 700 may also include a system memory 702, which may be in the form of random-access memory (RAM), read-only memory (ROM), or both.

A number of controllers and peripheral devices may also be provided, as shown in FIG. 7. An input controller 703 represents an interface to various input device(s) 704, such as a keyboard, mouse, or stylus. There may also be a scanner controller 705, which communicates with a scanner 706. System 700 may also include a storage controller 707 for interfacing with one or more storage devices 708 each of which includes a storage medium such as magnetic tape or disk, or an optical medium that might be used to record programs of instructions for operating systems, utilities, and applications, which may include embodiments of programs that implement various aspects of the present invention. Storage device(s) 708 may also be used to store processed data or data to be processed in accordance with the invention. System 700 may also include a display controller 709 for providing an interface to a display device 711, which may be a cathode ray tube (CRT), a thin film transistor (TFT) display, or other type of display. The computing system 700 may also include a printer controller 712 for communicating with a printer 713. A communications controller 714 may interface with one or more communication devices 715, which enables system 700 to connect to remote devices through any of a variety of networks including the Internet, an Ethernet cloud, a Fiber Channel over Ethernet (FCoE)/Data Center Bridging (DCB) cloud, a local area network (LAN), a wide area network (WAN), a storage area network (SAN) or through any suitable electromagnetic carrier signals including infrared signals.

In the illustrated system, all major system components may connect to a bus 716, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

It shall be noted that elements of the claims, below, may be arranged differently including having multiple dependencies, configurations, and combinations. For example, in embodiments, the subject matter of various claims may be combined with other claims.

What is claimed is:

1. A method for training a model to correlate a query to a relevant set of bidwords, the method comprising:
receiving a set of corresponding queries, bidwords, and click through rates, each of the queries comprising one or more words;
representing each word of a query as a vector representation;
representing each bidword as a vector representation, each bidword comprising one or more words;
training an attention-based model to assign a weight to the vector representations of the one or more query words and combine the weighted vector representations of the one of more query words with corresponding bidword vector representations; and
using the combination of the corresponding click through rate to form a regression for predicting the click through rate for the query.

2. The method of claim 1 further comprising segmenting a query into a plurality of components.

3. The method of claim 1 wherein the weighted computational representation of each bidword and corresponding query are inputs to the regression that outputs the click through rate.

4. The method of claim 1 wherein the vector representation of each bidword is a single vector.

5. The method of claim 4 wherein the single vector representation for each bidword is achieved by averaging a vector representation of each word the bidword.

6. The method of claim 4 wherein the single vector representation is achieved using a recurrent neural network.

7. The method of claim 1 wherein the vector representation is obtained using a look-up table.

8. The method of claim 1 wherein the model to correlate the query to a relevant bidword or bidwords is used to obtain a set of relevant bidwords for a query.

9. A method for obtaining relevant bidwords for a user query, the method comprising:
receiving a user query comprising one or more query words; and
inputting the one or more query words into an attention-based model, the attention-based model comprising:
converting each query word to a vector representation;
combining the vector representations of the query in a weighted fashion with a set of bidword representations to form a set of attention-based query-bidword combination vectors;
inputting each attention-based query-bidword combination vector into a regression to predict a click through rate value; and
outputting a set of bidwords that correspond to the attention-based query-bidword combination vector that produced click through rate values from the regression that are above a threshold value.

10. The method of claim 9 further comprising segmenting a query into a plurality of components.

11. The method of claim 9 wherein the converting each query word to a vector representation uses a table lookup to convert the query word to a vector representation.

12. The method of claim 9 wherein the vector representation of the bidword is a single vector.

13. The method of claim 12 wherein the single vector is achieved using a recurrent neural network.

14. The method of claim 12 wherein the single vector is achieved using an averaging of vector representations of vector representations of each word in a bidword.

15. The method of claim 9 wherein the combining each of the words of the query with a set of bidword representations weights each word of the query.

16. The method of claim 9 further comprising returning a search page based on the set of bidwords outputted.

17. A non-transitory computer-readable medium or media comprising one or more sequences of instructions which, when executed by one or more processors, causes steps for obtaining relevant bidwords for a user query to be performed, comprising:
receiving a user query comprising one or more query words; and
inputting the one or more query words into an attention-based model, the attention-based model comprising:
converting each query word to a vector representation;
combining the vector representations of the query in a weighted fashion with a set of bidword representations to form a set of attention-based query-bidword combination vectors;
inputting each attention-based query-bidword combination vector into a regression to predict a click through rate value; and
outputting a set of bidwords that correspond to the attention-based query-bidword combination vector that produced click through rate values from the regression that are above a threshold value.

18. The system of claim 17 further comprising a segment module capable of segmenting a query into a plurality of components.

19. The system of claim 17 wherein the vector representation of the bidword is a single vector.

20. The system of claim 17 further comprising returning a search page based on the set of bidwords outputted.
